(19) United States
(12) Patent Application Publication
(10) Pub. No.: US 2018/0221750 A1
(43) Pub. Date: Aug. 9, 2018

(54) LEAGUE INFORMATION INTEGRATION SYSTEM

(71) Applicant: Aaron Le, Stanton, CA (US)

(72) Inventor: Aaron Le, Stanton, CA (US)

(21) Appl. No.: 15/889,122

(22) Filed: Feb. 5, 2018

Related U.S. Application Data
(60) Provisional application No. 62/454,558, filed on Feb. 3, 2017.

(51) Int. Cl. A63B 71/06

(52) U.S. Cl. CPC A63B 71/0616; H04L 67/10; A63B 2243/0037

(57) ABSTRACT

A league information integration method and system include: registering a team including detecting a selection of the team, sending a registration request, detecting a registration request response, storing the selected team as a registered team, and displaying a team overview; scheduling a game including detecting a selection of the registered team as a home team, detecting a selection of another registered team as an away team, detecting a selection of a game time, detecting a selection of a game location, notifying the home team and the away team of the game time and the game location, and displaying the game including the game time and the game location; recording statistics for the game including displaying a home team member and an away team member, displaying an offensive statistic selection and a defensive statistic selection, and detecting the association of a statistic with the away team member.

### CROSS-REFERENCE TO RELATED APPLICATIONS

This claims priority benefit to all common subject matter of U.S. Provisional Patent Application 62/454,558 filed Feb. 3, 2017. The content of this applications is incorporated herein by reference.

### TECHNICAL FIELD

This disclosure relates to social network technology, more particularly to systems and methods of integrating league information for improving social network technology.

### BACKGROUND

Conventionally, league operators that want to do routine tasks, such as registering sports teams, scheduling games, and updating scores and statistics, would have to do their work on paper and pen, then transfer it over to their computer, then upload it online to their website, and then notify their members directly about the updates.

This conventional process can be very time consuming, tedious, and has a high risk of human error. Often time, these routine tasks require the league operators to block out an extended period of time in order to complete; therefore, resulting in delay of information. For example, a basketball game that is completed on a Wednesday night may not have the scores and statistics updated onto the league's website until Sunday evening.

In recent years the rise of computational systems for organizing teams, games, leagues, and collecting data has lead to a greater effectiveness and efficiency in terms of time and decision making. The organization of sports leagues and plays has become a sophisticated and involved activity, not only for professional sports leagues, but also for recreational sports leagues as well.

Numerical and biographical data are often used to rate or profile teams and players, and large numbers of graphs or drawings are involved in the generation and explanation of drills and plays. The application of computers to process data relating to the players is becoming more prevalent.

The information processing capabilities of computer-based team organizers allow a team manager or coach to rapidly access the team's roster information, individual player capabilities, and game histories, such as wins, losses, and scores. Game schedules may be generated based on the team's abilities to enhance the overall matchup of the games.

However, even with the greatly increased use of computational technology directed at rating or profiling players themselves, the process for organizing and managing leagues still relies almost entirely on the manual actions, subjective decisions, and personal knowledge of league organizers rather than a technology based solution for providing information, processes, and decision possibilities by way of purposefully designed league management systems and networked communications.

Solutions have been long sought but prior developments have not taught or suggested any complete solutions, and solutions to these problems have long eluded those skilled in the art. Thus there remains a considerable need for devices and methods that can provide a technology based solution for providing information, processes, and decision possibilities by way of purposefully designed league management systems and networked communications.

### SUMMARY

A league information integration system and methods, providing a technology based solution for providing information, processes, and decision possibilities by way of purposefully designed league management systems and networked communications, are disclosed. The league information integration system and methods can include: registering a team including: detecting a selection of the team as a selected team, the selection indicating registration of the team into a division, sending a registration request, the registration request sent to a team captain of the selected team, detecting a registration request response indicating the selected team has accepted the registration request, storing the selected team as a registered team including storing athletic information and personal information of a member of the registered team in a league management data base based on the registration request being accepted, and displaying a team overview based on the registration request being accepted; scheduling a game including: detecting a selection of the registered team as a home team, detecting a selection of another registered team as an away team, detecting a selection of a game time, detecting a selection of a game location, notifying the home team and the away team of the game time and the game location, and displaying the game including the game time and the game location; and recording statistics for the game including: displaying a home team member and an away team member as selectable options, displaying an offensive statistic selection and a defensive statistic selection, and detecting the association of a statistic with the away team member.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The league information integration system is illustrated in the figures of the accompanying drawings which are meant to be exemplary and not limiting, in which like reference numerals are intended to refer to like components, and in which:

FIG. 1 is an exemplary distributed computer system according to an embodiment of the league information integration system.

FIG. 2 is a graphical depiction of the league information integration system in a display social networking league profile step.

FIG. 3 is a graphical depiction of the league information integration system in a display social network register to league select team step.

FIG. 4 is a graphical depiction of the league information integration system in a display social network register to league select division step.

FIG. 5 is a graphical depiction of the league information integration system in a display social network register to league registration overview step.

FIG. 6 is a graphical depiction of the league information integration system in a display social network register to league registration request confirmation step.

FIG. 7 is a graphical depiction of the league information integration system in a display league management system team registration tasks step.

FIG. 8 is a graphical depiction of the league information integration system in a display league management system team registration tasks options step.

FIG. 9 is a graphical depiction of the league information integration system in a display league management system team registration confirmation step.

FIG. 10 is a graphical depiction of the league information integration system in a display league management system registered team general information step.

FIG. 11 is a graphical depiction of the league information integration system in a display league management system registered team roster step.

FIG. 12 is a graphical depiction of the league information integration system in a display league management system registered team member general information step.

FIG. 13 is a graphical depiction of the league information integration system in a display league management system game scheduling screen step.

FIG. 14 is a graphical depiction of the league information integration system in a display league management system game scheduling options step.

FIG. 15 is a graphical depiction of the league information integration system in a display league management system game scheduling confirmation step.

FIG. 16 is a graphical depiction of the league information integration system in a display league management system game schedules calendar step.

FIG. 17 is a graphical depiction of the league information integration system in a display social network game schedules notification step.

FIG. 18 is a graphical depiction of the league information integration system in a display social network league profile schedules step.

FIG. 19 is a graphical depiction of the league information integration system in a display league management system team statistics comparison step.

FIG. 20 is a graphical depiction of the league information integration system in a display league management system game tip off confirmation step.

FIG. 21 is a graphical depiction of the league information integration system in a display league management system game start first half selection step.

FIG. 22 is a graphical depiction of the league information integration system in a display league management system statistics keeping initial screen step.

FIG. 23 is a graphical depiction of the league information integration system in a display league management system statistics keeping point selection step.

FIG. 24 is a graphical depiction of the league information integration system in a display league management system statistics keeping player selection step.

FIG. 25 is a graphical depiction of the league information integration system in a display league management system statistics keeping updated statistics step.

FIG. 26 is a graphical depiction of the league information integration system in the display social networking social network league profile schedules step of FIG. 18 during a live broadcast of the game.

FIG. 27 is a graphical depiction of the league information integration system in a display social networking game statistics box score screen step.

FIG. 28 is a control flow for the league information integration system.

### DETAILED DESCRIPTION

In the following description, reference is made to the accompanying drawings that form a part hereof, and in which are shown by way of illustration, embodiments in which the league information integration system may be practiced. It is to be understood that other embodiments may be utilized and structural changes may be made without departing from the scope of the league information integration system.

When features, aspects, or embodiments of the product development system are described in terms of steps of a process, an operation, a control flow, or a flow chart, it is to be understood that the steps would be recognized as algorithmic steps, can be combined, performed in a different order, deleted, or include additional steps without departing from the product development system as described herein.

The league information integration system is described in sufficient detail to enable those skilled in the art to make and use the league information integration system and provide numerous specific details to give a thorough understanding of the league information integration system; however, it will be apparent that the league information integration system may be practiced without these specific details.

In order to avoid obscuring the league information integration system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGs. Generally, the league information integration system can be operated in any orientation.

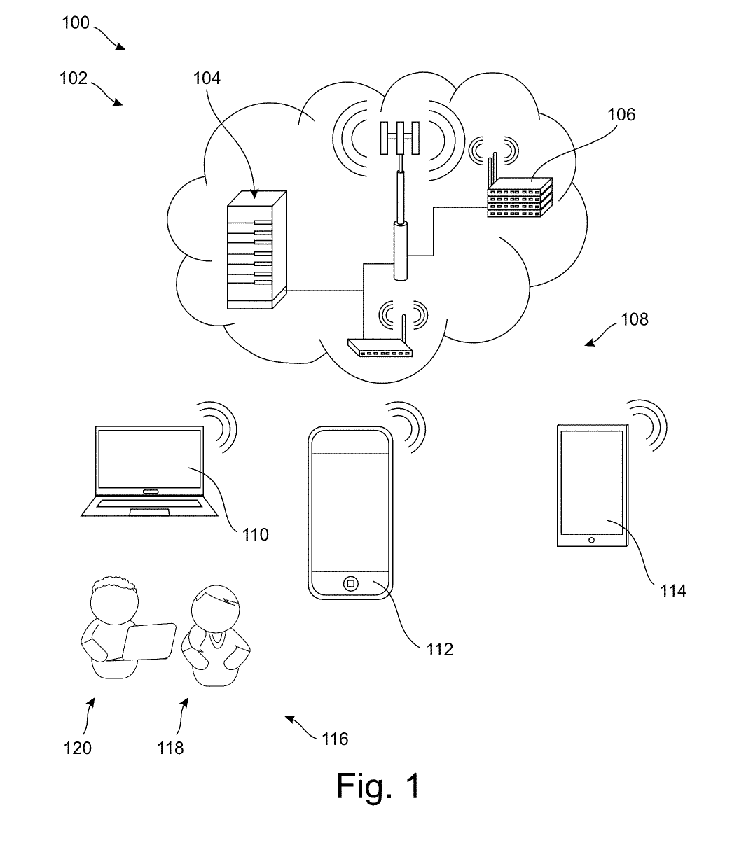

Referring now to FIG. 1, therein is shown an exemplary distributed computer system according to an embodiment of the league information integration system 100. The league information integration system 100 can include elements of a distributed computing system 102 including servers 104, routers 106, and other telecommunications infrastructure.

The distributed computing system 102 can include the Internet, a wide area network, (WAN), a metropolitan area network (MAN), a local area network (LAN), a telephone network, cellular data network (e.g., 3G, 4G) and/or a combination of these and other networks (wired, wireless, public, private or otherwise).

The servers 104 can function both to process and store data for use on user devices 108 including laptops 110, cellular phones 112, and tablet computers 114. It is contemplated that the servers 104 and the user devices 108 can individually comprise a central processing unit, memory, storage and input/output units and other constituent components configured to execute applications including software suitable for displaying user interfaces, the interfaces optionally being generated by a remote server, interfacing with the cloud network, and managing or performing capture, transmission, storage, analysis, display, or other processing of data and or images.

For the purposes of this application it is to be understood that when operations are described in terms of process steps, including retrieving steps, storing steps, displaying steps, detecting steps, calculating steps, and determining steps, the steps are performed by the central processing unit of either the servers 104, the user devices 108, or a combination thereof. Further, for the purposes of this application it is to be understood that when operations are described in terms of process steps, the steps can be executed by instructions configured to execute the step residing in non-transitory computer readable medium. Specifically for display steps, it is to be understood that the display steps are raw information stored in the user devices 108 or the servers 104 processed by the central processing units of the user devices 108 or the servers 104 and displayed on the user devices 108.

The servers 104 and the user devices 108 of the league information integration system 100 can run applications based on Objective-C for iOS and Java for Android, and can further include a web browser operative for, by way of example, retrieving web pages or other markup language streams, presenting those pages or streams, executing scripts, controls and other code on those pages or streams, accepting user input with respect to those pages or streams, and issuing HTTP requests with respect to those pages or streams. The web pages or other markup language can be in HAML, CSS, HTML, Ruby on Rails or other conventional forms, including embedded XML, scripts, controls, and so forth as adapted in accord with the teachings hereof. The user devices 108 and the servers 104 can be used individually or in combination to store and process information from the league information integration system 100 in the form of protocol, parameters, images, protocol instructions and protocol guides.

Further depicted are users 116. The users 116 can interface with the league information integration system 100. The users 116 can include members 118 such as team members, team captains. The users 116 can further include observers 120 that are not necessarily members of a team.

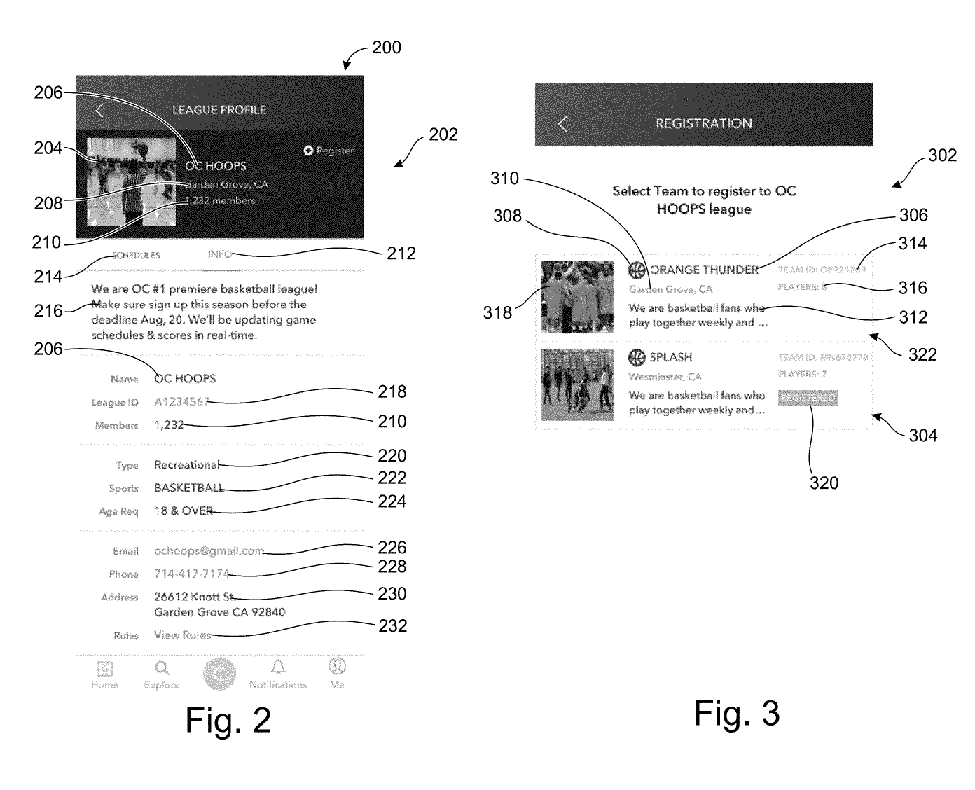

Referring now to FIG. 2, therein is shown a graphical depiction of the league information integration system 100 of FIG. 1 in a display social networking league profile step. The display social networking league profile step can allow the users 116 of FIG. 1 to easily assess an overview of the league. A league profile 200 can be displayed including a league header 202.

The league header can include a league image 204, a league name 206, a league location 208, a number of league members 210. Further, the league profile 200 can display a league information tab 212 and a league schedules tab 214.

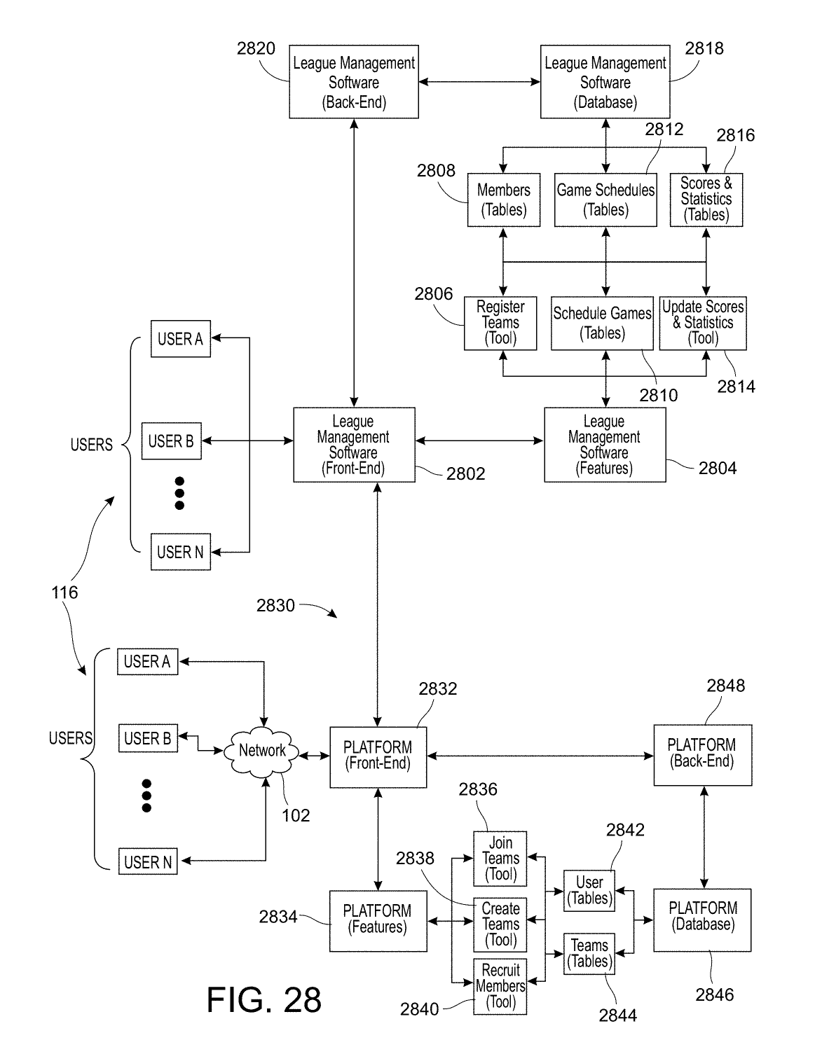

The league information tab 212 can include a league statement 216, the league name 206, a league identification mark 218, the number of league members 210, a league type 220, a sports type 222, a league age requirement 224, a league email contact information 226, a league phone number 228, a league address 230, and a league rules selection 232. The a league schedule tab 214 can include a schedule of games for teams belonging to the league. The information in the league profile can be retrieved from the league management data base 2818 of FIG. 28.

Referring now to FIG. 3, therein is shown a graphical depiction of the league information integration system 100 of FIG. 1 in a display social network register to league select team step. The display social network register to league select team step can display a list of teams 302 for selection by one of the users 116 of FIG. 1. The teams 302 can be selected for registering one of the teams 302 into a division of the league.

The teams 302 can be displayed with a list of team profiles 304 for selection, each of the team profiles 304 on the list of teams can include a team name 306, a sports type icon 308, a team location 310, a team description 312, a team identification 314, a team player count 316, and a team image 318. It is contemplated that each of the teams 302 already registered to a league can include a registered indication 320.

The league information integration system 100 can detect a selection of one of the teams 302 by the user 116. The league information integration system 100 can recognize the selection of the users 116 as a selected team 322.

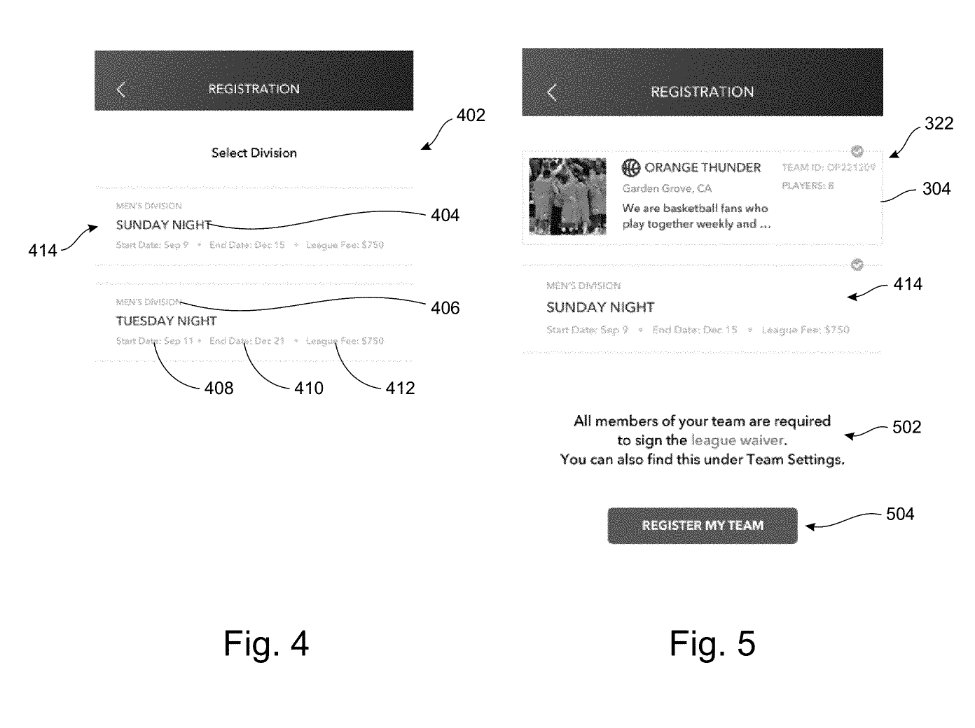

Referring now to FIG. 4, therein is shown a graphical depiction of the league information integration system 100 of FIG. 1 in a display social network register to league select division step. The display social network register to league select division step can display league divisions 402 for selection by one of the users 116 of FIG. 1.

The league divisions 402 can include a division name 404, a division identifier 406, a division start date 408, a division end date 410, and a league fee 412. The league information integration system 100 can detect a selection of one of the league divisions 402 as a selected division 414.

Referring now to FIG. 5, therein is shown a graphical depiction of the league information integration system 100 of FIG. 1 in a display social network register to league registration overview step. The display social network register to league registration overview step can display the team profile 304 for the selected team 322 and the selected division 414 selected by the users 116 of FIG. 1 in the display social network register to league select team step of FIG. 3 and the display social network register to league select division step of FIG. 4.

Further, a registration instructions 502 along with a selection to register the selected team 504 can be displayed. The league information integration system 100 can detect a selection of the register the selected team 504 and can send a registration request to a team captain of the selected team 322.

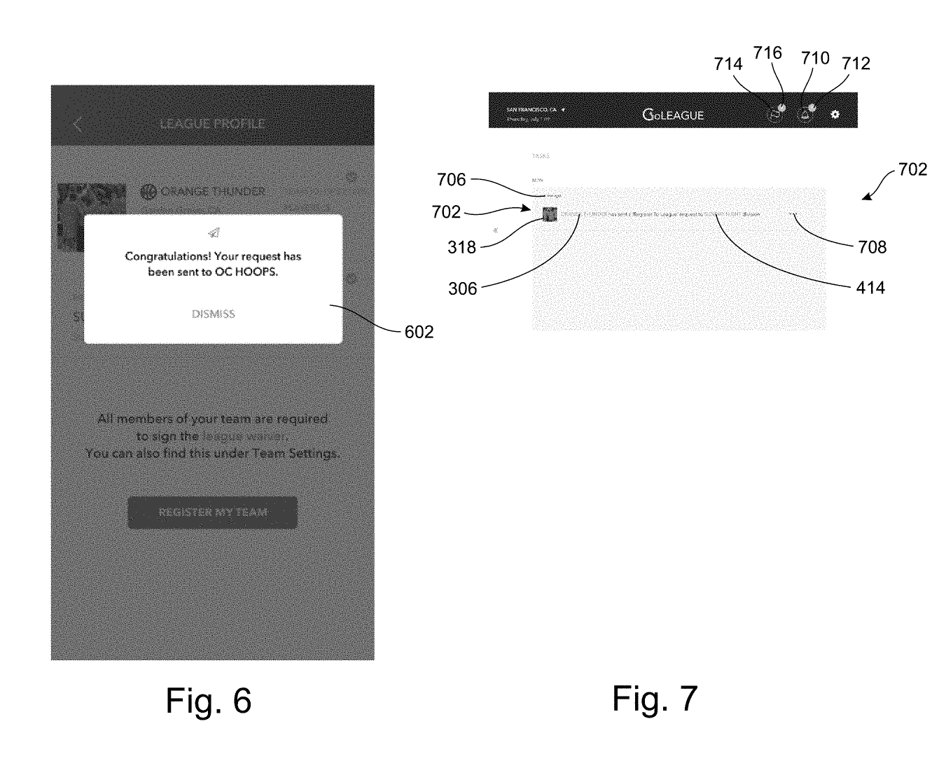

Referring now to FIG. 6, therein is shown a graphical depiction of the league information integration system 100 of FIG. 1 in a display social network register to league registration request confirmation step. The display social network register to league registration request confirmation step can display a registration request confirmation notification 602 that the registration request was sent to the team captain of the selected team 322 of FIG. 3.

Referring now to FIG. 7, therein is shown a graphical depiction of the league information integration system 100 of FIG. 1 in a display league management system team registration tasks step. The display league management system team registration tasks step can display a list of registration tasks 702 requiring attention and action by the users 116 of FIG. 1. The registration tasks 702 can include a registration request 704, the registration request 704 including a time 706 the registration request was sent, the team image 318, the team name 306, the selected division 414, and options 708. Further, the registration tasks screen can include a notifications icon 710 with a number of notifications 712 and a flagged items icon 714 with a number of flagged items 716.

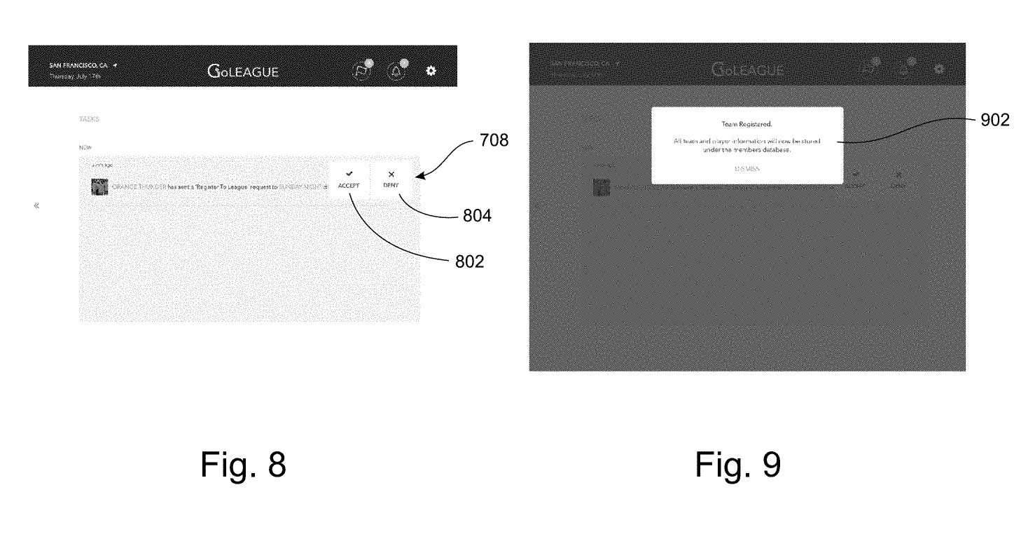

Referring now to FIG. 8, therein is shown a graphical depiction of the league information integration system 100 of FIG. 1 in a display league management system team registration tasks options step. The display league management system team registration tasks options step can display the options 708 of FIG. 7 including an accept registration 802 and a deny registration 804. The accept registration 802 and the deny registration 804 options can be displayed once the options 708 of FIG. 7 is selected by the users 116 of FIG. 1 and the selection is detected by the league information integration system 100.

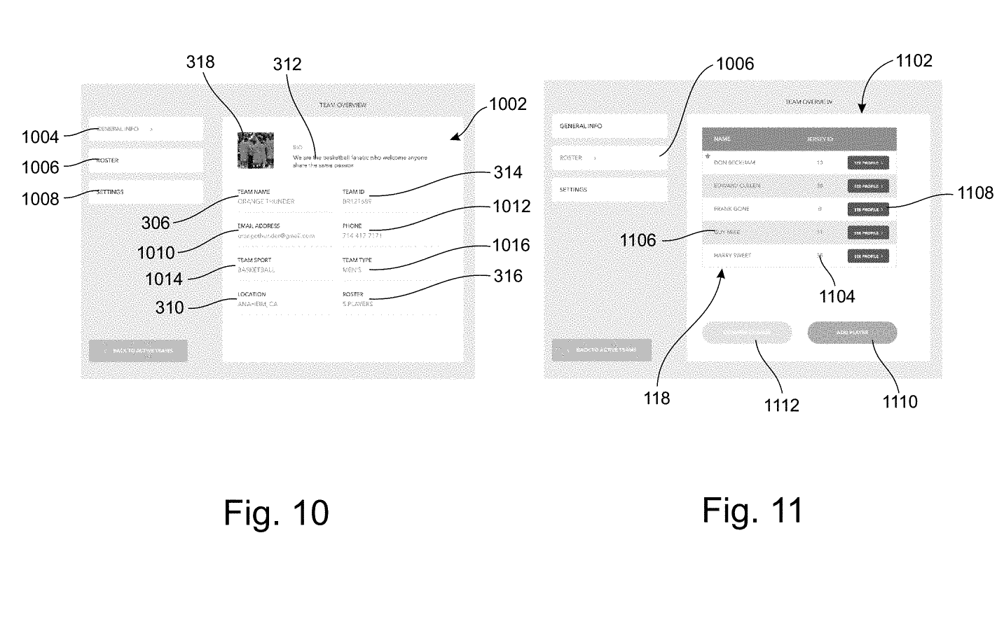

Referring now to FIG. 9, therein is shown a graphical depiction of the league information integration system 100 of FIG. 1 in a display league management system team registration confirmation step. The display league management system team registration confirmation step can display a team registered notification 902 on the task screen based on the league information integration system 100 detecting the accept registration 802 of FIG. 8 option was selected by the users 116 of FIG. 1 indicating the selected team 322 of FIG. 3 has accepted the registration request 704 of FIG. 7. The league information integration system 100 can store the selected team 322 as the registered team 1002 of FIG. 10.

Referring now to FIG. 10, therein is shown a graphical depiction of the league information integration system 100 of FIG. 1 in a display league management system registered team general information step. The display league management system registered team general information step can display a registered team 1002. Once the league information integration system 100 detects the selected team 322 of FIG. 3 has accepted the registration request 704 of FIG. 7, the league information integration system 100 can store player information and team information on the league management data base 2818 of FIG. 28, more particularly on the members table 2808 of FIG. 28 within the league management data base 2818.

The display league management system registered team general information step can display the registered team 1002 along with a general information tab 1004, a roster tab 1006, and a setting s tab 1008. The general information tab 1004 can include the team image 318 of the registered team 1002, the team description 312 for the registered team 1002, the team name 306 for the registered team 1002, the team identification 314 for the registered team 1002, a team email address 1010 for the registered team 1002, a team phone number 1012 for the registered team 1002, the sport type 1014 for the registered team 1002, the team type 1016 for the registered team 1002, the team location 310 of the registered team 1002, and the player count 316 for the registered team 1002.

Referring now to FIG. 11, therein is shown a graphical depiction of the league information integration system 100 of FIG. 1 in a display league management system registered team roster step. The display league management system registered team roster step can display a roster 1102 of the registered team 1002 of FIG. 10 based on the league information integration system 100 detecting the roster tab 1006 was selected by the users 116 of FIG. 1.

The roster 1102 can include a list of the members 118 of the registered team 1002. For each of the members 118, the roster 1102 can include a jersey ID 1104, a player name 1106, and a see profile option 1108. The roster 1102 can further show an add player option 1110 and a confirm change option 1112. The confirm change option 1112 can be deactivated until the league information integration system 100 detects a member 118 has been added or member information has been changed in the roster 1102.

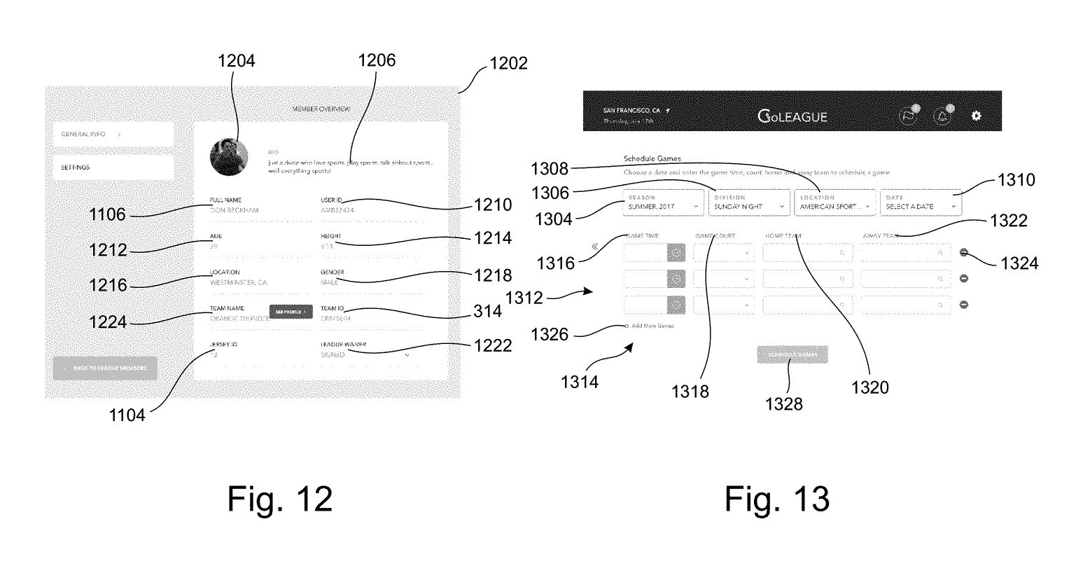

Referring now to FIG. 12, therein is shown a graphical depiction of the league information integration system 100 of FIG. 1 in a display league management system registered team member general information step. The display league management system registered team member general information step can display a member overview 1202 for one of the members 118 of FIG. 1 of the registered team 1002 of FIG. 10.

The member overview 1202 can be displayed based on the league information integration system 100 detecting a selection of the see profile 1108 of FIG. 11 for one of the members 118 of the registered team 1002. The member overview can include a player image 1204, a player statement 1206, a player name 1106, a player ID 1210, a player age 1212, a player height 1214, a player location 1216, a player gender 1218, a jersey ID 1104, and a league waver notification 1222 providing a notification of whether any action is required by the member 118 to conform with the league waiver requirements.

For the purposes of this application, a member is to be understood as a player and the two words are to be interchangeable for the purposes of this application. The member overview 1202 can further display an associated team 1224 that player is a member of, and the team ID of the associated team the player is a member of.

Referring now to FIG. 13, therein is shown a graphical depiction of the league information integration system 100 of FIG. 1 in a display league management system game scheduling screen step. The display league management system game scheduling screen step can display a game scheduling screen 1302 including a season selection box 1304 a division selection box 1306 a location selection box 1308 a date selection box 1310, rows 1312, and columns 1314 for entering game information.

The game information can include time selection boxes 1316 arranged as one of the columns, court selection boxes 1318 arranged as one of the columns, home team selection boxes 1320 arranged as one of the columns, away team selection boxes 1322 arranged as one of the columns, and delete row selections 1324 arranged as one of the columns.

The game scheduling screen 1302 can further include an add more games selection 1326 for adding an additional row and a schedule games selection 1328 which can be activated based on the league information integration system 100 detecting the game information is complete for one of the rows 1312.

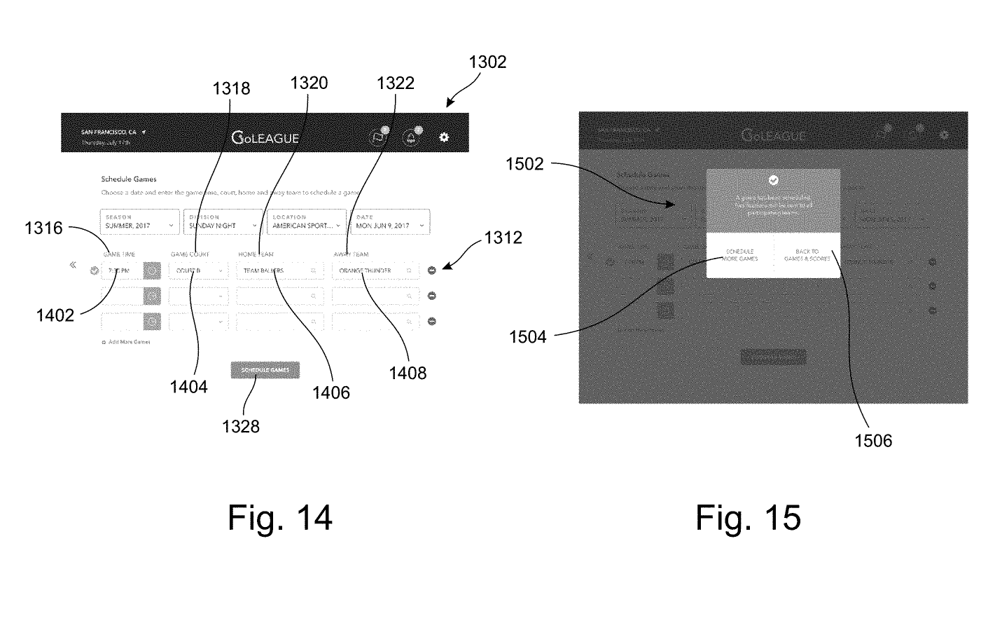

Referring now to FIG. 14, therein is shown a graphical depiction of the league information integration system 100 of FIG. 1 in a display league management system game scheduling options step. The display league management system game scheduling options step can display the game scheduling screen 1302 having the game information in the first of the rows 1312 filled out. The league information integration system 100 can detect the entry of the game information by the users 116 of FIG. 1 into the time selection boxes 1316 the court selection boxes 1318 the home team selection boxes 1320 the away team selection boxes 1322.

Specifically, the game scheduling screen 1302 can include the game information entered in the time selection box 1316 including a game time 1402, the court selection box 1318 including a game location 1404, the home team selection box 1320 including the home team 1406, and the away team selection box 1322 including the away team 1408.

Once the league information integration system 100 detects that all of the game information has been completed and populated for one of the rows 1312, the league information integration system 100 can display the schedule games selection 1328 as activated. That is, the schedule games selection 1328 can be activated based on the game time 1402 being detected, the game location 1404 being detected, the home team 1406 being detected, and the away team 1408 being detected.

Referring now to FIG. 15, therein is shown a graphical depiction of the league information integration system 100 of FIG. 1 in a display league management system game scheduling confirmation step. The display league management system game scheduling confirmation step can display a game scheduling confirmation 1502. The game scheduling confirmation 1502 can include a schedule more games option 1504 and a navigational option 1506.

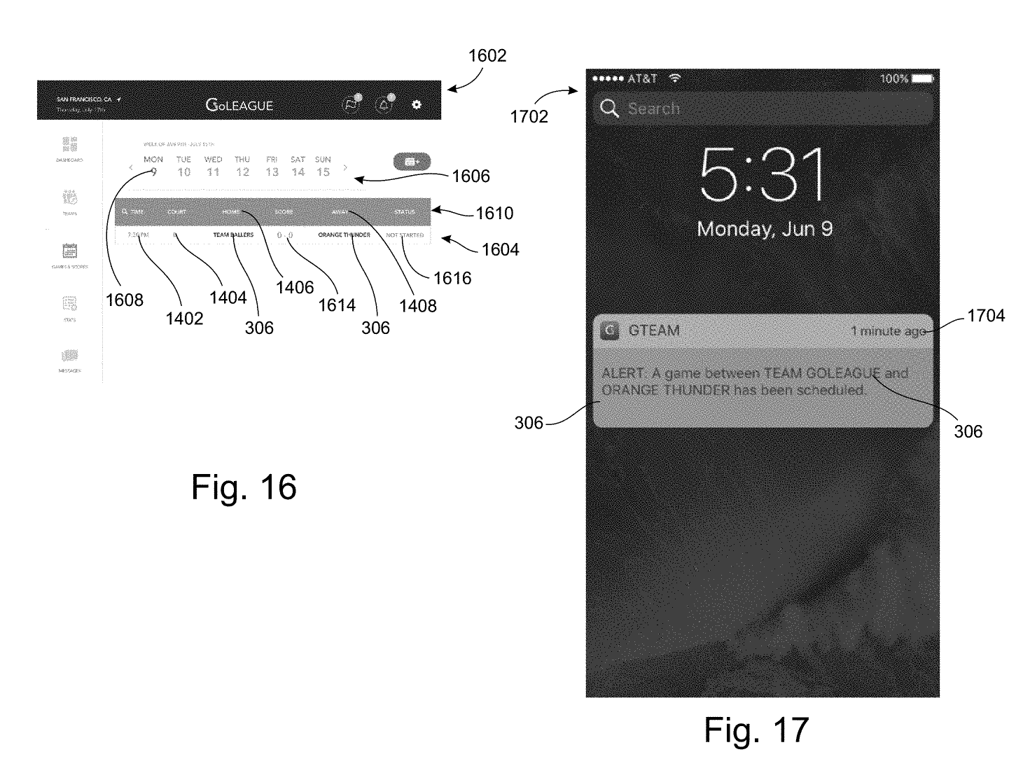

It is contemplated that the league information integration system 100 can detect the schedule games selection 1320 being selected by the users 116 of FIG. 1 and can notify the home team 1406 and the away team 1508 as shown in FIGS. 16-18.

Referring now to FIG. 16, therein is shown a graphical depiction of the league information integration system 100 of FIG. 1 in a display league management system game schedules calendar step. The display league management system game schedules calendar step can display a calendar 1602 including the games 1604 scheduled, for example, in FIG. 14.

The calendar can include a week 1606 with numerical dates for selection, an identified day 1608 within the week, a header 1610, the game time 1402, the game location 1404, the team name 306 of the home team 1406, a score 1614, the team name 306 of the away team 1408, and a game status 1616.

Referring now to FIG. 17, therein is shown a graphical depiction of the league information integration system 100 of FIG. 1 in a display social network game schedules notification step. The display social network game schedules notification step can display a game scheduling notification 1702.

The game scheduling notification 1702 can be a popup alert on a telephone lock screen for the members 118 of FIG. 1 of the home team 1406 of FIG. 14 and the away team 1408 of FIG. 14. The game scheduling notification 1702 can include a time stamp 1704, the team name 306 of the home team 1406 and the team name 306 of the away team 1408.

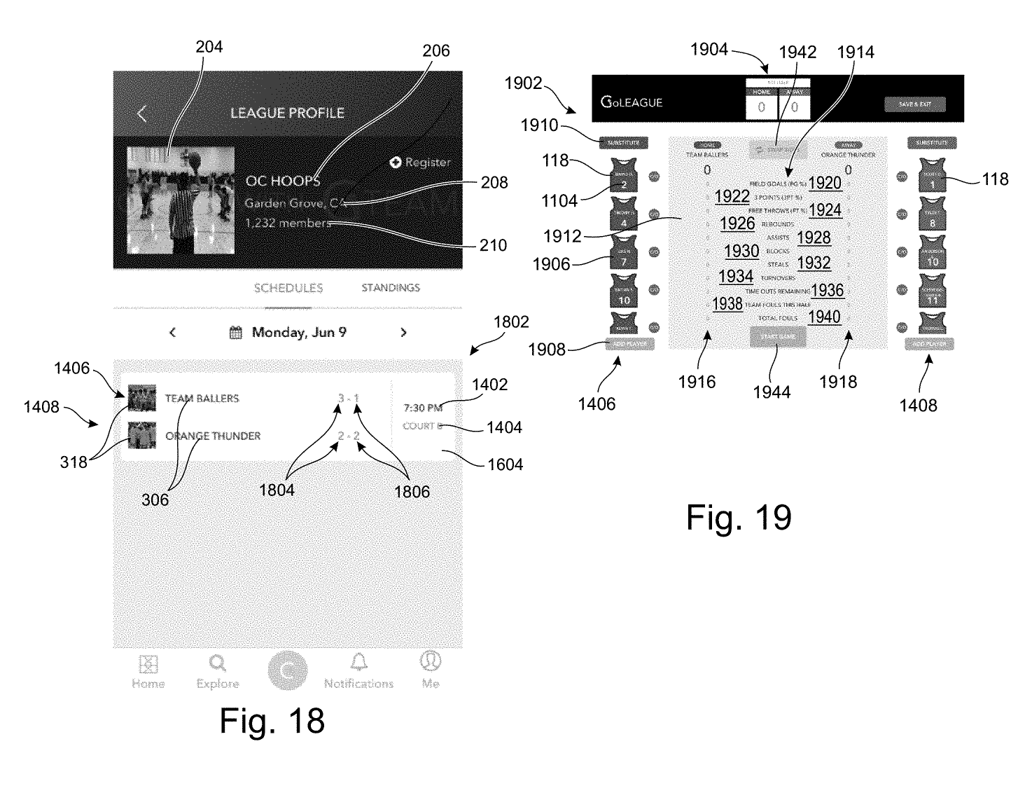

Referring now to FIG. 18, therein is shown a graphical depiction of the league information integration system 100 of FIG. 1 in a display social network league profile schedules step. The display social network league profile schedules step can display a league profile schedule 1802 including the game 1604.

Displaying the game 1604 can include displaying the league name 206, the league image 204, the league location 208, a number of league members 210, the team image 318 of the home team 1406, the team name 306 of the home team 1406, a number of games won 1804 by the home team 1406, a number of games lost 1806 by the home team 1406, the team image 318 of the away team 1408, the team name 306 of the away team 1408, the number of games won 1804 by the away team 1406, the number of games lost 1806 by the away team 1408, the game time 1402, and the game location 1408.

Referring now to FIG. 19, therein is shown a graphical depiction of the league information integration system 100 of FIG. 1 in a display league management system team statistics comparison step. The display league management system team statistics comparison step can display a game statistics screen 1902. The game statistics screen can include a score 1904 including total points scored for the home team 1406 and total points scored for the away team 1408.

The game statistics screen 1902 can display, for example, the home team 1406 on one half of the screen with the away team 1408 on the other half of the screen. For example, the home team 1406 can be displayed with the members 118 of the home team 1406 on the left side and the away team 1408 can be displayed with the members 118 of the away team 1408 on the right side.

It is contemplated that symbols 1906 can be used to depict the members 118, such as jerseys. The jersey ID 1104 can be displayed on the symbols 1906 for clear and quick reference. An add player selection 1908 can be displayed below the list of the members 118 for both the home team 1406 and the away team 1408. A substitute player selection 1910 can be displayed above the list of the members 118 for both the home team 1406 and the away team 1408.

In the center of the game statistics screen 1902, a statistics counter 1912 can be displayed. The statistics counter 1912 can include a center list of statistics 1914 with a home counter 1916 and an away counter 1918 for both the home team 1406 and the away team 1408, respectively.

The center list of statistics 1914 can include a field goal percentage 1920, a three point percentage 1922, a free throw percentage 1924, rebounds 1926, assists 1928, blocks 1930, steals 1932, turnovers 1934, timeouts remaining 1936, team fouls this half 1938, and total fouls 1940.

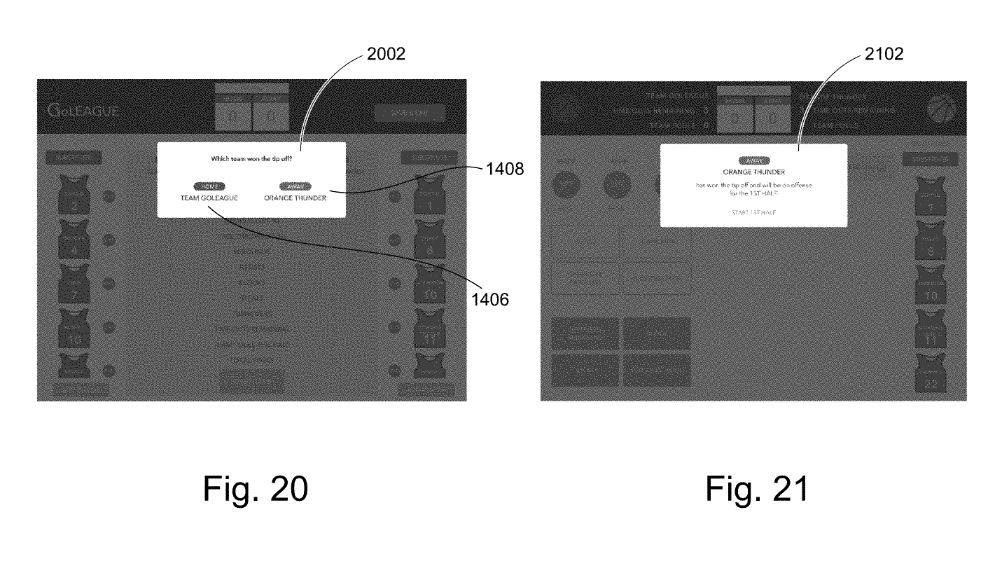

A swap sides selection 1942 can be displayed over the center list of statistics 1914 and can swap the home team 1406 and the away team 1408 from one side to the other. Below the center list of statistics 1914, a start game selection 1944 can be displayed. The league information integration system 100 can detect when the start game selection 1944 is selected by the users 116 of FIG. 1 and can initiate the statistics capturing process including displaying the tip off confirmation screen 2002 of FIG. 20.

Referring now to FIG. 20, therein is shown a graphical depiction of the league information integration system 100 of FIG. 1 in a display league management system game tip off confirmation step. The display league management system game tip off confirmation step can display a tip off confirmation screen 2002 having a selection for the home team 1406 and the away team 1408 for who won the tip off. It is contemplated that the tip off confirmation screen can be different for each sport including a coin toss for football, for example. Illustratively, the tip off confirmation screen 2002 can be overlaid on the game statistics screen 1902 with the game statistics screen 1902 greyed out.

Referring now to FIG. 21, therein is shown a graphical depiction of the league information integration system 100 of FIG. 1 in a display league management system game start first half selection step. The display league management system game start first half selection step can display a tip off wining notification. For example, the league information integration system 100 can detect the selection of the home team 1406 of FIG. 14 or the away team 1408 of FIG. 14 on the tip off confirmation screen 2002 of FIG. 20 and can display a tip off notice 2102 of the team that won the tip off or any initial starting point for the game 1604 of FIG. 16.

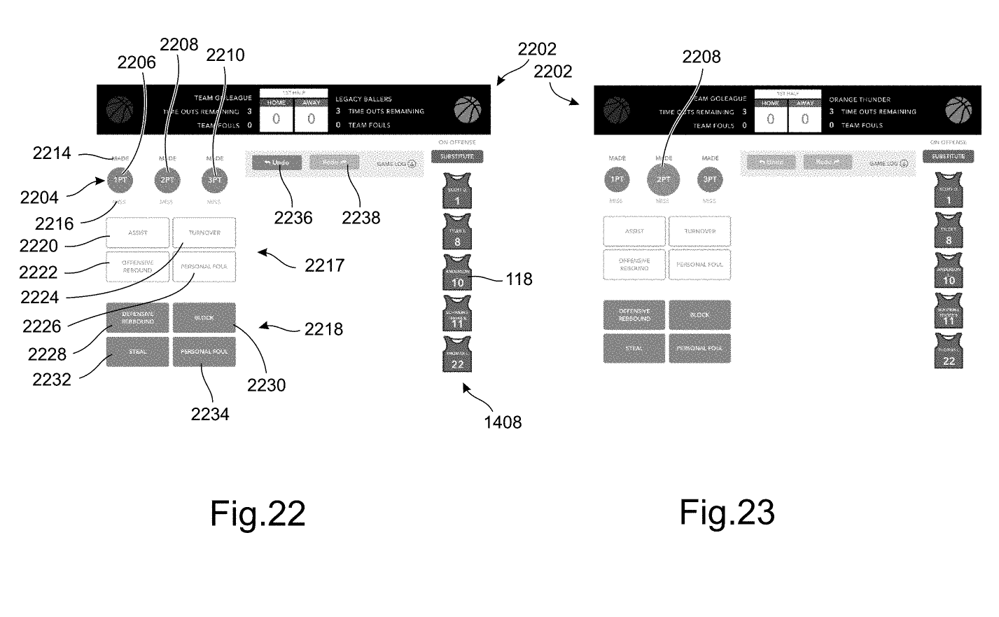

Referring now to FIG. 22, therein is shown a graphical depiction of the league information integration system 100 of FIG. 1 in a display league management system statistics keeping initial screen step. The display league management system statistics keeping initial screen step can display a statics entering screen 2202 for tracking the statistics during the game 1604 of FIG. 16.

Illustratively, the statics entering screen 2202 can be displayed separately for both the home team 1406 of FIG. 14 and the away team 1408. As depicted the away team 1408 is depicted in the statics entering screen 2202 having the away team 1408 members 118 listed vertically.

The statics entering screen 2202 can include point selections 2204 including one point 2206, two point 2208, and three point 2210 selections. Above the point selections 2204, made selections 2212 can be displayed. The made selections 2214 can be selected by the users 116 of FIG. 1 when points are made by one of the members 118 of the away team 1408.

Below the point selections 2204, miss selections 2214 can be displayed. The miss selections 2216 can be selected by the users 116 when points are not made but an attempt was made.

The statics entering screen 2202 can further display offensive statistics selections 2217 and defensive statistics selections 2218. It is contemplated that when the away team 1408 is on offense, the statics entering screen 2202 can display the offensive statistics selections 2217 active and the defensive statistics selections 2218. Alternatively, when the away team 1408 is on defense, the statics entering screen 2202 can display the offensive statistics selections 2217 as deactivated and the defensive statistics selections 2218 as activated.

The offensive statistics selections 2217 can include assists 2220, turnovers 2222, offensive rebounds 2224, and offensive personal fouls 2226. The defensive statistics selections 2218 can include defensive rebound 2228, blocks 2230, steals 2232, and defensive personal fouls 2234. The statics entering screen 2202 can further display undo 2236 and redo 2238 selections for ease in correcting any statistics that are entered.

Referring now to FIG. 23, therein is shown a graphical depiction of the league information integration system 100 of FIG. 1 in a display league management system statistics keeping point selection step. The display league management system statistics keeping point selection step can indicate a points selection has been detected by the league information integration system 100 by making the two point 2208 selection larger, for example.

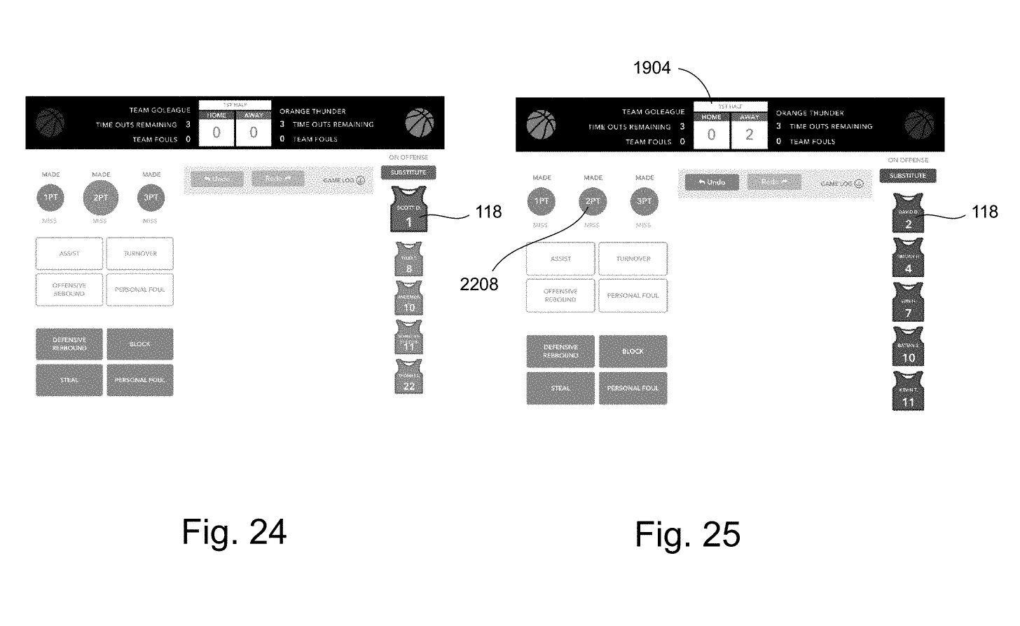

Referring now to FIG. 24, therein is shown a graphical depiction of the league information integration system 100 of FIG. 1 in a display league management system statistics keeping player selection step. The display league management system statistics keeping player selection step can indicate one of the members 118 has been selected and that the selection has been detected by the league information integration system 100 by making the member 118 selected larger, for example.

Referring now to FIG. 25, therein is shown a graphical depiction of the league information integration system 100 of FIG. 1 in a display league management system statistics keeping updated statistics step. The display league management system statistics keeping updated statistics step can display an updated score 1904 for example by after the two point 2208 selection was selected in FIG. 23 and matched with the member 118 in FIG. 24.

As such it is contemplated that the statics entering screen 2202 can be the update scores and statistics tool 2814 of FIG. 28 for updating the scores and statistics table 2816 of FIG. 28 during a live game.

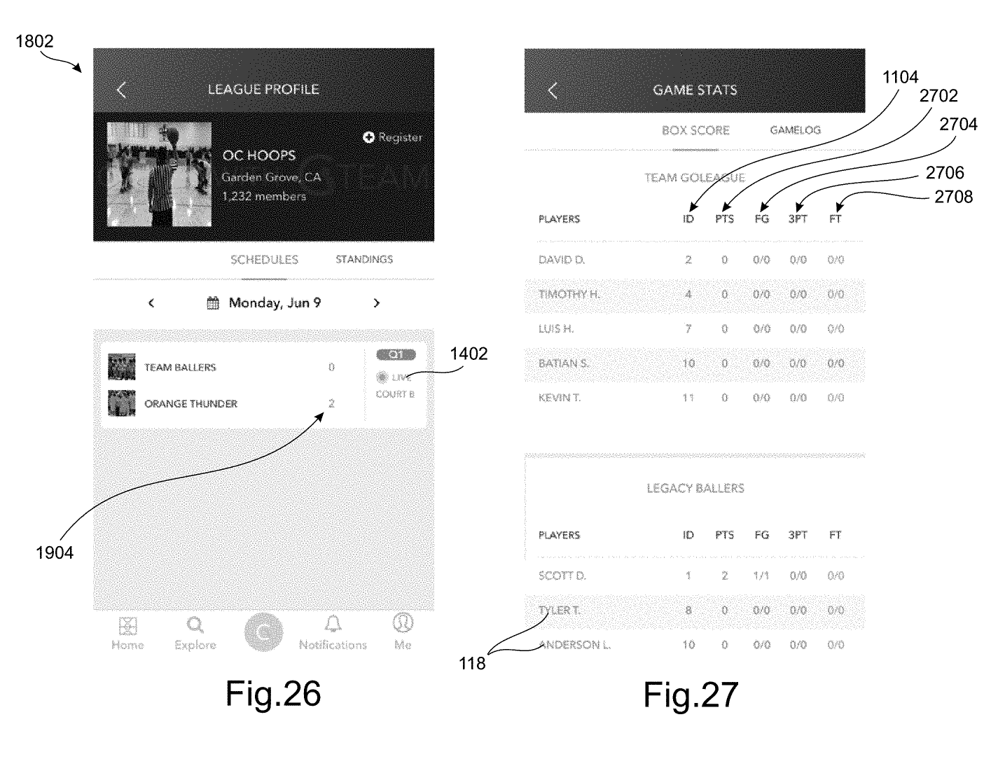

Referring now to FIG. 26, therein is shown a graphical depiction of the league information integration system 100 of FIG. 1 in the display social network league profile schedules step of FIG. 18 during a live broadcast of the game 1604 of FIG. 16. The display social network league profile schedules step can display the league profile schedule 1802 with the game time 1402 indicating the game is live and indicating the current score 1904.

Referring now to FIG. 27, therein is shown a graphical depiction of the league information integration system 100 of FIG. 1 in a display social networking game statistics box score screen step. The display social networking game statistics box score screen step can display a set of statistics for the home team 1406 and the away team 1408. It is contemplated that the league information integration system 100 could retrieved the statistical information from the scores and statistics table 2816 of FIG. 28.

The statistics that can be displayed can include rows for the members 118 and columns for the statistics for each of the members 118.

Illustratively, the columns could include the jersey ID 1104 for the members 118, individual points 2702 for each of the members 118, individual field goals 2704 for each of the members 118, three point scores 2706 for each of the members 118, and free throws 2708 for each of the members 118.

Referring now to FIG. 28, therein is shown a control flow for the league information integration system. The control flow is shown having the users 116 interfacing with front end league management software 2802 through the distributed computing system 102.

The front end league management software 2802 can interface with league management software features 2804 and backend league management software 2806. The league management software features 2804 can include the register teams tool 2806 for example as described with regard to FIGS. 2-12. Illustratively, when a team is registered in FIGS. 2-12, the team profiles 304 of FIG. 3 of the registered team 1002 can be entered into member's tables 2808.

The league management software features 2804 can further be implemented to schedule games as is depicted in FIGS. 13-18, for example. It is contemplated that when the games are scheduled, the games, the teams, and the members 118 of FIG. 1 can be entered onto schedule games tables 2810 and the schedule games tables 2810 can be used to select the home team 1406 of FIG. 14 and the away team 1408 of FIG. 14 based on the information contained within the schedule games tables 2810.

Once the games are scheduled, it is contemplated that the information including the team profiles can be stored on a game schedules table 2812. The league management software features 2804 can further interface and provide the users 116 access to an update scores and statistics tool 2814.

Illustratively, the update scores and statistics tool 2814 can be implemented and shown as the tools displayed and disclosed in FIGS. 19-27. The update scores and statistics tool 2814 can provide an interface to the users 116 and can store the information about the statistics of the team members 118 within scores and statistics tables 2816.

The member's tables 2808, the game schedules table 2812, and the scores and statistics tables 2816 can be stored in a league management database 2818. a league management software backend 2820 can interface with the front end league management software 2802 and the league management database 2818.

The league information integration system 100 is further shown interfacing with a team formation system 2830. The team formation system 2830 is depicted having the users 116 interfacing with the team formation system 2830 through the distributed computing system 102.

The team formation system 2830 can include a platform front-end 2832 providing platform features 2834 including a join teams tool 2836, a create teams tool 2838, and a recruit member tool 2840. The join teams tool 2836, the create teams tool 2838, and the recruit member tool 2840 can query both a team member table 2842 and the team table 2844 residing in a team database 2846. The platform front-end 2832 and the database 2846 can interface with a platform back end 2848.

Thus, it has been discovered that the league information integration system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the league information integration system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

More particularly, it has been discovered that registering a team including: detecting a selection of the team as a selected team, the selection indicating registration of the team into a division, sending a registration request, the registration request sent to a team captain of the selected team, detecting a registration request response indicating the selected team has accepted the registration request, storing the selected team as a registered team including storing athletic information and personal information of a member of the registered team in a league management data base based on the registration request being accepted, and displaying a team overview based on the registration request being accepted; scheduling a game including: detecting a selection of the registered team as a home team, detecting a selection of another registered team as an away team, detecting a selection of a game time, detecting a selection of a game location, notifying the home team and the away team of the game time and the game location, and displaying the game including the game time and the game location; and recording statistics for the game including: displaying a home team member and an away team member as selectable options, displaying an offensive statistic selection and a defensive statistic selection, and detecting the association of a statistic with the away team member produce non-abstract improvements because this data-structure and this set of rules reduces complexity in league information integration and data usage thus reducing overall computing requirements in terms of processing overhead, data transmission, storage overhead and power consumption. Yet further, this data-structure and this set of rules enables computing systems to accomplish league information integration by implementing computing processes which humans did not previously employ.

What is claimed is:

1. A league information integration method comprising:
registering a team including:
detecting a selection of the team as a selected team, the selection indicating registration of the team into a division,
sending a registration request, the registration request sent to a team captain of the selected team,
detecting a registration request response indicating the selected team has accepted the registration request,
storing the selected team as a registered team including storing athletic information and personal information of a member of the registered team in a league management data base based on the registration request being accepted, and
displaying a team overview based on the registration request being accepted;
scheduling a game including:
detecting a selection of the registered team as a home team,
detecting a selection of another registered team as an away team,
detecting a selection of a game time,
detecting a selection of a game location,
notifying the home team and the away team of the game time and the game location, and
displaying the game including the game time and the game location; and
recording statistics for the game including:
displaying a home team member and an away team member as selectable options,
displaying an offensive statistic selection and a defensive statistic selection, and
detecting the association of a statistic with the away team member.

2. The method of claim 1 wherein detecting the selection of the team to register includes displaying a league profile, the league profile including a league header, and a league info tab; the league header including:
a league image,
a league name,
a league location, and
a number of league members,
the league info tab including:
a league statement,
the league name,
a league identification mark,
a number of league members,
a league type,
a sports type, and
a league age requirement.

3. The method of claim 1 wherein detecting the selection of the team as a selected team includes displaying a list including a team profile for user selection, the team profiles including a team name, a sports type icon, a team location, a team description, a team identification, a team player count, and a registered indicator.

4. The method of claim 1 further comprising displaying a list including a division within a league to select from, the list including a division name, a division identifier, a division start date, a division end date, and a league fee.

5. The method of claim 1 wherein sending the registration request includes displaying a team profile of the selected team, displaying a selected division, displaying a registration instruction, and displaying a selection to register the selected team.

6. The method of claim 1 further comprising displaying a tasks screen, the tasks screen including the registration request, the registration request including a time the registration request was sent, a team icon, a team name, a selected division, and options, the options including an accept registration request and a deny registration request.

7. The method of claim 1 where in displaying the team overview includes displaying a general info tab, a roster tab and a settings tab:
the general info tab including a team image of the registered team, a team description for the registered team, a team name for the registered team, a team ID for the registered team, a sport type for the registered team, a team type for the registered team, a location of the registered team, a player count for the registered team;
the roster tab including a list including the members of the registered team, a jersey ID, a player name, and a see profile option.

8. The method of claim 1 wherein scheduling the game includes displaying a schedule game interface including:
displaying a season selection box with a selected season;
displaying a division selection box with a selected division;
displaying a location selection box with a selected location;
displaying a date selection box with a selected date;
displaying the game as a row with columns;
displaying a time selection box arranged as one of the columns;
displaying a court selection box arranged as one of the columns;
displaying a home team selection box arranged as one of the columns;
displaying an away team selection box arranged as one of the columns; and
displaying a delete selection for the row.

9. The method of claim 8 wherein scheduling the game includes:
detecting a game time selected for the time selection box, a game location selected for the court selection box, the home team selected for the home team selection box, and the away team selected for the away team selection box;
displaying a schedule game selection as an activated selection option based on the game time being detected, the game location being detected, the home team being detected, and the away team being detected.

10. The method of claim 9 wherein notifying the home team and the away team includes notifying the home team and the away team based on a detection of the schedule games selection being select by a user.

11. The method of claim 1 wherein displaying the game includes:
displaying a week with a numerical date for selection,
displaying an identified day within the week,
displaying the game time, the game location, home team name, a score, an away team name, and a game status.

12. The method of claim 1 wherein notifying the home team and the away team includes notifying the home team member and the away team member of the game with a popup alert on a telephone lock screen, the popup alert including a time stamp, a home team name, an away team name, and an indication that the game has been scheduled.

13. The method of claim 1 wherein displaying the game includes displaying a league name, a league image, a league location, a number of league members, a home team image, a home team name, home team games won, home team games lost, an away team image, an away team name, away team games won, away team games lost, the game time, and the game location.

14. The method of claim 1 further comprising displaying a tip off confirmation screen having a selection for the home team and the away team.

15. The method of claim 1 wherein displaying the offensive statistics selections and the defensive statistics selections includes displaying the offensive statistics selections for the away team as deactivated and the defensive statistics selections for the away team as activated based on the away team being on defense.

16. The method of claim 1 wherein detecting the association of a statistic with the away team member includes detecting the association of a point, a field goal, a field goal percentage, a three point shot, a three point shot percentage, a free throw, a free throw percentage, a rebound, an assist, a steal, a block, a turnover, a personal foul, and a time out with the member.

17. Computer readable medium, in useful association with a processor, with instructions configured to:
register a team including:
detect a selection of the team as a selected team, the selection indicating registration of the team into a division,
send a registration request, the registration request sent to a team captain of the selected team,
detect a registration request response indicating the selected team has accepted the registration request,
store the selected team as a registered team including storing athletic information and personal information of a member of the registered team in a league management data base based on the registration request being accepted, and
display a team overview based on the registration request being accepted;
schedule a game including:
detect a selection of the registered team as a home team,
detect a selection of another registered team as an away team,
detect a selection of a game time,
detect a selection of a game location,
notify the home team and the away team of the game time and the game location, and
display the game including the game time and the game location;
record statistics for the game including:
display a home team member and an away team member as selectable options,
display an offensive statistic selection and a defensive statistic selection, and
detect the association of a statistic with the away team member.

18. A league information integration system comprising:
a processor configured to register a team including:
detect a selection of the team as a selected team, the selection indicating registration of the team into a division,
send a registration request, the registration request sent to a team captain of the selected team,
detect a registration request response indicating the selected team has accepted the registration request, and
store the selected team as a registered team including storing athletic information and personal information of a member of the registered team in a league management data base based on the registration request being accepted;
the processor configured to schedule a game including:
detect a selection the registered team as a home team,
detect a selection of another registered team as an away team,
detect a selection of a game time,
detect the selection of a game location, and
notify the home team and the away team of the game time and the game location;
the processor configured to record statistics for the game including:
detect the association of a statistic with the away team member;
a display configured to:
display a team overview based on the registration request being accepted,
display the game including the game time and the game location,
display a home team member and an away team member as selectable options, and
display an offensive statistic selection and a defensive statistic selection.

19. The system of claim 18 wherein the processor configured to detect the association of the statistic includes the processor configured to store the statistic on a scores and statistics table in the league management data base.

20. The system of claim 18 wherein the league management data base includes a members table, a game schedule table, a scores and statistics table, and a schedule games table.
